(19) United States
(12) Patent Application Publication
(10) Pub. No.: US 2015/0307357 A1
(43) Pub. Date: Oct. 29, 2015

(54) PRODUCTION OF GRAPHENE NANORIBBONS BY OXIDATIVE ANHYDROUS ACIDIC MEDIA

(71) Applicants: James M. Tour, Bellaire, TX (US); Ayrat Dimiev, Basking Ridge, NJ (US)

(72) Inventors: James M. Tour, Bellaire, TX (US); Ayrat Dimiev, Basking Ridge, NJ (US)

(73) Assignee: William Marsh Rice University, Houston, TX (US)

(21) Appl. No.: 14/333,104

(22) Filed: Jul. 16, 2014

Related U.S. Application Data
(60) Provisional application No. 61/847,158, filed on Jul. 17, 2013.

(51) Int. Cl. C01B 31/04

(52) U.S. Cl. CPC C01B 31/0446; C01B 31/0438; C01B 2204/04; C01B 2204/06

(57) ABSTRACT

In some embodiments, the present disclosure pertains to methods of producing graphene nanoribbons by exposing carbon nanotubes to a medium to result in formation of the graphene nanoribbons from the carbon nanotubes. In some embodiments, the carbon nanotubes include multi-walled carbon nanotubes. In some embodiments, the medium comprises: (a) an acid, (b) a dehydrating agent, and (c) an oxidizing agent. In some embodiments, the acid comprises sulfuric acid, the dehydrating agent comprises oleum (e.g., with a free sulfur trioxide (SO₃) content of about 20% by weight of the oleum), and the oxidizing agent comprises ammonium persulfate. In some embodiments, the exposing opens the carbon nanotubes parallel to their longitudinal axis to form graphene nanoribbons. Additional embodiments of the present disclosure pertain to the graphene nanoribbons that are formed by the methods of the present disclosure. In some embodiments, the graphene nanoribbons are non-oxidized, un-functionalized and substantially free of defects.

### CROSS-REFERENCE TO RELATED APPLICATIONS

This application claims priority to U.S. Provisional Patent Application No. 61/847,158, filed on Jul. 17, 2013. The entirety of the aforementioned application is incorporated herein by reference.

### STATEMENT REGARDING FEDERALLY SPONSORED RESEARCH

This invention was made with government support under Grant No. FA 9550-09-1-0581, awarded by the U.S. Department of Defense. The government has certain rights in the invention.

### BACKGROUND

Current methods of unzipping carbon nanotubes (CNTs) for graphene nanoribbon (GNR) production suffer from numerous limitations, including reaction speed, reaction efficiency, multiple reaction steps, reaction safety, high costs, limited scalability, and limited GNR quality. As such, a need exists for improved methods of forming GNRs from CNTs that address the aforementioned limitations.

### SUMMARY

In some embodiments, the present disclosure pertains to methods of producing graphene nanoribbons. In some embodiments, the methods include a step of exposing carbon nanotubes to an oxidative anhydrous acidic medium (also referred to as a medium) to form a dispersion of carbon nanotubes in the medium, where the exposing results in formation of graphene nanoribbons from the carbon nanotubes. Additional embodiments of the present disclosure also include one or more steps of terminating the formation of graphene nanoribbons and separating the formed graphene nanoribbons from the medium. In some embodiments, the methods of the present disclosure lack a reduction step after the formation of graphene nanoribbons.

In some embodiments, the carbon nanotubes that are used to form graphene nanoribbons include multi-walled carbon nanotubes. In some embodiments, the media used to form graphene nanoribbons include: (a) an acid, (b) a dehydrating agent, and (c) an oxidizing agent. In some embodiments, the acid includes sulfuric acid, the dehydrating agent includes oleum (e.g., oleum with a free sulfur trioxide (SO₃) content of about 20% by weight of the oleum), and the oxidizing agent includes a persulfate ion-containing compound (e.g., ammonium persulfate). In additional embodiments, the acid includes sulfuric acid, the dehydrating agent includes diphosphorus pentoxide (P₂O₅), and the oxidizing agent includes a persulfate ion-containing compound (e.g., ammonium persulfate).

In some embodiments, the carbon nanotubes are exposed to a medium by stirring the medium. In some embodiments, the exposing occurs at temperatures of about 5° C. to about 100° C. In some embodiments, the exposing occurs for about 1 minute to about 10 minutes.

In some embodiments, the exposing opens the carbon nanotubes parallel to their longitudinal axis to form graphene nanoribbons. In some embodiments, the exposing leads to intercalation of media components between the walls of the carbon nanotubes. In some embodiments, the intercalation creates a strain within the carbon nanotubes. In some embodiments, the strain leads to the longitudinal opening of the carbon nanotubes to form graphene nanoribbons.

Additional embodiments of the present disclosure pertain to the graphene nanoribbons that are formed by the methods of the present disclosure. In some embodiments, the graphene nanoribbons include from about 1 layer to about 100 layers. In some embodiments, the graphene nanoribbons are non-oxidized. In some embodiments, the graphene nanoribbons lack graphene oxide nanoribbons. In some embodiments, the graphene nanoribbons have a flattened structure. In some embodiments, the graphene nanoribbons have a foliated structure. In some embodiments, the graphene nanoribbons are substantially free of defects. In some embodiments, the graphene nanoribbons are un-functionalized. In some embodiments, the graphene nanoribbons are pristine.

### DESCRIPTION OF THE FIGURES

FIG. 1 provides a scheme of a method of forming graphene nanoribbons (GNRs) by exposure of carbon nanotubes (CNTs) to an oxidative anhydrous acidic medium (also referred to as a medium).

FIG. 2 provides a scanning electron microscopy (SEM) image of GNRs prepared by exposure of multi-walled carbon nanotubes (MWNTs) to a medium containing (NH₄)₂S₂O₈, H₂SO₄, and oleum (with a free SO₃ content of about 20% by weight of the oleum) ((NH₄)₂S₂O₈/H₂SO₄/oleum). The vast majority of the MWNTs are opened longitudinally (i.e. unzipped).

FIG. 3 provides thermogravimetric analysis (TGA) data for GNRs and the parent MWNTs from FIG. 2. The insignificant weight loss of the formed GNRs suggests that the GNRs are non-oxidized.

FIG. 4 provides a Cl s X-ray photoelectron spectroscopy (XPS) spectrum of the GNRs from FIG. 2. The spectrum contains a single peak at 284.5 eV, corresponding to elemental carbon. The weak π-π* band at 291 eV is indicative of the intact graphitic carbon. The survey spectrum shows only 2.5%-4.5% oxygen on different spots of different samples, which is typical for any non-oxidized carbon material.

FIG. 5 shows the Raman spectra of GNRs (red) and the parent MWNTs (black) from FIG. 2. The higher D-peak in GNRs compared to that in MWNTs is attributed to the ribbon's edges, formed as a result of unzipping.

FIG. 6 provides SEM images of MWNTs and GNRs formed from exposure of the MWNTs to various media. FIG. 6A shows an SEM image of MWNTs. FIG. 6B shows an SEM image of MWNTs stirred in H₂SO₄. FIGS. 6C-D show SEM images of GNRs formed from exposure of MWNTs to a medium containing (NH₄)₂S₂O₈, H₂SO₄, and P₂O₅ ((NH₄)₂S₂O₈/H₂SO₄/P₂O₅). The scale bars in FIGS. 6A, B and D represent 1 μm. The scale bar in FIG. 6D represents 5 μm.

FIG. 7 shows SEM images of MWNTs that were split by their exposure to (NH₄)₂S₂O₈/H₂SO₄/P₂O₅. The rectangle in each image represents the area of higher magnification in the next image. The scale bars represent 1 mm (FIG. 7A), 100 μm (FIG. 7B), 10 μm (FIG. 7C), and 1 μm (FIG. 7D).

FIG. 8 provides SEM (FIG. 8A) and atomic force microscopy (AFM) (FIG. 8B) images of (NH₄)₂S₂O₈/H₂SO₄/P₂O₅ split MWNTs. The scale bars represent 10 μm. The vertical distance between the markers in FIG. 8B is 285.0 nm.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Current methods of unzipping carbon nanotubes (CNTs) for graphene nanoribbon (GNR) production include oxidative unzipping with potassium permanganate (KMnO₄) in concentrated sulfuric acid (H₂SO₄) to afford graphene oxide nanoribbons (GONRs) that can subsequently be reduced to GNRs. Such methods are relatively inexpensive and suitable for mass production. However, the resulting GONRs may become significantly damaged by the introduction of oxygen functionalities and point defects into otherwise intact graphene planes. Moreover, any follow-up reduction of GONRs may not fully reinstate the original graphene structure.

Additional methods of unzipping CNTs to form GNRs include intercalation assisted splitting of carbon nanotubes by various reagents, including lithium metal in liquid ammonia, potassium metal vapors, and liquid phase sodium/potassium alloys. Such intercalation assisted methods yield intact, electrically conductive GNRs. However, such methods may require excessive amounts of solvents and special conditions. For instance, intercalation assisted splitting of CNTs with lithium metal in liquid ammonia media may require low temperatures to keep ammonia in liquid form. Such methods may also require very large volumes of ammonia along with excess of lithium. In addition, use of highly reactive lithium, sodium and potassium metals may require additional safety precautions, which could in turn increase the cost of GNR production. Such costs may further increase if the reactions are conducted at high temperatures (e.g., >250° C.) for prolonged periods of time (e.g., more than 24 hours).

Moreover, many of the current methods of unzipping CNTs to form GNRs require direct physical contact between the carbon nanotubes and the reaction medium components. For instance, the intercalation assisted splitting of CNTs with potassium and sodium alloys requires direct physical contact between the CNTs and the alloy components. Such direct physical contact can in turn prolong the reaction times and lead to the formation of GNRs with more defects.

As such, a need exists for improved methods of forming GNRs from CNTs that address the aforementioned limitations. The present disclosure addresses this need.

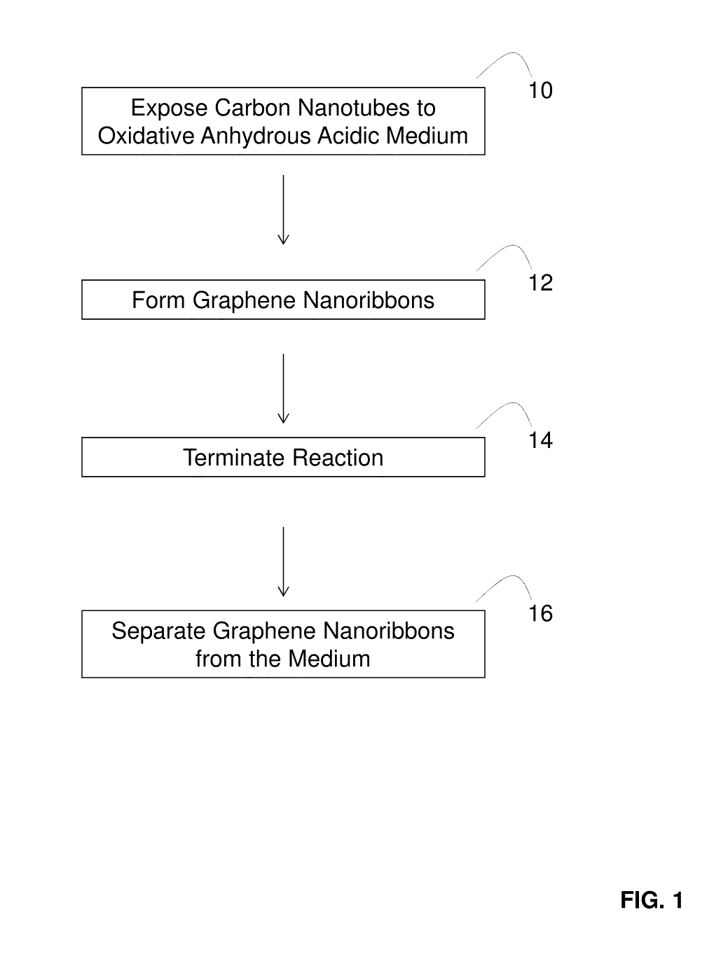

In some embodiments, the present disclosure pertains to improved methods of producing graphene nanoribbons. In some embodiments that are illustrated in FIG. 1, such methods include exposing carbon nanotubes to an oxidative anhydrous acidic medium (also referred to as a medium) to form a dispersion of carbon nanotubes in the medium (step 10), where the exposing results in formation of graphene nanoribbons from the carbon nanotubes in the medium (step 12). In some embodiments, the methods of the present disclosure also include a step of terminating the reaction (step 14). In some embodiments, the methods of the present disclosure also include a step of separating the formed graphene nanoribbons from the medium (step 16). Further embodiments of the present disclosure pertain to graphene nanoribbons, such as the graphene nanoribbons formed by the methods of the present disclosure.

As set forth in more detail herein, the methods of the present disclosure can have various embodiments. For instance, various types of carbon nanotubes may be exposed to various media under various conditions to form various types of graphene nanoribbons. Moreover, various methods may be used to terminate reactions and separate the formed graphene nanoribbons from the anhydrous media.

Carbon Nanotubes

The methods of the present disclosure can utilize various types of carbon nanotubes for graphene nanoribbon formation. For instance, in some embodiments, the carbon nanotubes include, without limitation, single-walled carbon nanotubes, double-walled carbon nanotubes, multi-walled carbon nanotubes, ultra-short carbon nanotubes, pristine carbon nanotubes, functionalized carbon nanotubes, and combinations thereof. In more specific embodiments, the carbon nanotubes include multi-walled carbon nanotubes. In some embodiments, the multi-walled carbon nanotubes include, without limitation, double-walled carbon nanotubes, triple-walled carbon nanotubes, quadruple-walled carbon nanotubes, and combinations thereof. In some embodiments, the multi-walled carbon nanotubes are un-functionalized. The use of additional carbon nanotubes for graphene nanoribbon formation can also be envisioned.

Exposing of Carbon Nanotubes to Media

Various methods may be utilized to expose the carbon nanotubes of the present disclosure to various media. For instance, in some embodiments, the carbon nanotubes may be exposed to a medium by physically adding the carbon nanotubes to the medium. In some embodiments, the carbon nanotubes may be exposed to a medium by stirring a dispersion of the carbon nanotubes in the medium. In some embodiments, the stirring occurs by mechanical stirring in the absence of stir bars.

The carbon nanotubes of the present disclosure may be exposed to a medium at various temperatures. For instance, in some embodiments, the exposing occurs at temperatures that range from about 5° C. to about 100° C. In some embodiments, the exposing occurs at a temperature of about 100° C. In some embodiments, the exposing occurs at temperatures that range from about 5° C. to about 25° C. In some embodiments, the exposing occurs at a temperature of about 25 ° C. In some embodiments, the exposing occurs at a temperature of about 50° C.

In addition, the carbon nanotubes of the present disclosure may be exposed to a medium for various periods of time. For instance, in some embodiments, the exposing occurs for about 1 minute to about 180 minutes. In some embodiments, the exposing occurs for about 1 minute to about 10 minutes. In some embodiments, the exposing occurs for about 5 minutes. In more specific embodiments, the carbon nanotubes of the present disclosure are exposed to a medium by stirring a dispersion of the carbon nanotubes in the medium for about 5 minutes at 100° C.

In some embodiments, the media of the present disclosure are in the form of a solution. In some embodiments, the solution contains dissolved carbon nanotubes and media components. In some embodiments, the solution is a liquid solution,

In some embodiments, the media of the present disclosure are in the form of a suspension. In some embodiments, the suspension contains suspended carbon nanotubes and media components. In some embodiments, the suspension is a liquid suspension, a solid suspension, a gaseous suspension, and combinations thereof. In some embodiments, the suspension is a liquid suspension. In more specific embodiments, the suspension is a liquid and gaseous suspension. The use of additional media can also be envisioned.

In some embodiments, media that contain carbon nanotubes and media components may have various properties that facilitate the formation of graphene nanoribbons. For instance, in some embodiments, the media have an oxidation potential that ranges from about 50 mV to about 600 mV when compared to pure sulfuric acid (i.e. sulfuric acid with purities of more than about 96%). In some embodiments, the media have an electrochemical potential that ranges from about 50 mV to about 310 mV when compared to pure sulfuric acid. In some embodiments, the media have a re-dox potential that ranges from about 250 mV to about 350 mV when compared to pure sulfuric acid. In some embodiments, the components of the media of the present disclosure help provide the aforementioned properties.

Media

In the present disclosure, media generally refer to mixtures of components that have oxidative, anhydrous or acidic properties. For instance, in some embodiments, the media of the present disclosure can have an anhydrous component (e.g., a dehydrating agent) that can absorb water from the medium. In some embodiments, the media of the present disclosure can have an acidic component (e.g., an acid) that is capable of intercalating between the walls of the carbon nanotubes in the medium. In some embodiments, the media of the present disclosure can contain an oxidative component (e.g., an oxidizing agent) that is capable of maintaining the oxidation potential of the medium at a level that longitudinally opens the carbon nanotubes to form graphene nanoribbons without oxidizing the graphene nanoribbons.

In some embodiments, the media of the present disclosure can contain components that are capable of enhancing the electrochemical potential of the medium. In some embodiments, the media of the present disclosure contain components that are capable of enhancing the re-dox potential of the medium. In some embodiments, the media of the present disclosure are referred to as oxidative anhydrous acidic media.

In more specific embodiments, the media of the present disclosure include, without limitation, the following components: (1) an acid, (2) a dehydrating agent, and (3) an oxidizing agent. As set forth in more detail herein, the media of the present disclosure can include various types of acids, dehydrating agents, and oxidizing agents.

Acids

The media of the present disclosure can include various types of acids. For instance, in some embodiments, suitable acids can include any acids that are capable of intercalating between the walls of carbon nanotubes in a medium. In some embodiments, suitable acids include, without limitation, mineral acids, diprotic acids, monoprotic acids, Bronsted acids, Lewis acids, and combinations thereof. In some embodiments, suitable acids include, without limitation, sulfuric acid, chlorosulfonic acid, nitric acid, perchloric acid, perbromic acid, periodic acid, and combinations thereof.

In more specific embodiments, the acid in the media of the present disclosure includes sulfuric acid. In some embodiments, the sulfuric acid is a commercially available sulfuric acid. In some embodiments, the sulfuric acid has a concentration ranging from about 96% to about 98%. In some embodiments, the sulfuric acid has a concentration of about 96%. The inclusion of additional acids in the media of the present disclosure can also be envisioned.

Dehydrating Agents

The media of the present disclosure can also include various types of dehydrating agents. For instance, in some embodiments, suitable dehydrating agents can include any dehydrating agent that is capable of absorbing water from a medium. In some embodiments, the dehydrating agent includes, without limitation, diphosphorus pentoxide (P₂O₅), sulfur trioxide (SO₃), alumina (Al₂O₃), calcium chloride (CaCl₂), calcium sulfate (CaSO₄), magnesium sulfate (MgSO₄), potassium carbonate (K₂CO₃), sodium sulfate (Na₂SO₄), and combinations thereof.

In more specific embodiments, the dehydrating agents of the present disclosure include diphosphorus pentoxide (P₂O₅). In additional embodiments, the dehydrating agents of the present disclosure include sulfur trioxide (SO₃).

In some embodiments, the dehydrating agent includes oleum. In some embodiments, the oleum has a free sulfur trioxide (SO₃) content of about 20% by weight of the oleum. In some embodiments, the medium that includes oleum has a free sulfur trioxide (SO₃) content that ranges from about 0% to about 20% by weight of the medium. In more specific embodiments, the medium that includes oleum has a free sulfur trioxide (SO₃) content that ranges from about 1% to about 2% by weight of the medium. In additional embodiments, the medium that includes oleum has a free sulfur trioxide (SO₃) content of about 1.6% by weight of the medium. The inclusion of additional dehydrating agents in the media of the present disclosure can also be envisioned.

Oxidizing Agents

The media of the present disclosure can include various types of oxidizing agents. In some embodiments, the oxidizing agents of the present disclosure include oxidizing agents that are capable of enhancing the electrochemical potential of the media in which they are dissolved in. For instance, in some embodiments, the oxidative agent of the present disclosure may be added to a sulfuric acid-oleum mixture to provide a medium with an electrochemical potential of more than about 100 mV, but less than about 400 mV when compared to pure sulfuric acid.

In some embodiments, the oxidizing agents include, without limitation, hydrogen peroxide, chromates, dichromates, chlorates, perchlorates, osmium tetroxide, nitrates, nitrogen oxides, nitric acid, persulfate ion-containing compounds, and combinations thereof.

In more specific embodiments, the oxidizing agents of the present disclosure include one or more persulfate ion-containing compounds. In some embodiments, the persulfate ion containing compounds of the present disclosure have a persulfate ion. In some embodiments, the persulfate ion in the persulfate ion-containing compounds of the present disclosure include, without limitation, dipersulfate (S₂O₈²⁻), peroxymonosulfate (SO₅²⁻), hydrogen dipersulfate (HS₂O₈⁻), hydrogen peroxymonosulfate (HSO₅⁻), peroxydisulfuric acid (H₂S₂O₈), peroxymonosulfuric acid (H₂SO₅⁻), and combinations thereof.

In some embodiments, the persulfate ion-containing compounds of the present disclosure may be associated with a cation. In some embodiments, the cation in the persulfate ion-containing compounds of the present disclosure include, without limitation, ammonium, sodium, potassium, lithium, cesium, group 1 metals, group 2 metals, and combinations thereof.

In more specific embodiments, the oxidizing agents of the present disclosure include ammonium persulfate. In additional embodiments, the oxidizing agents of the present disclosure include Oxone® (KHSO₅.0.5KHSO₄.0.5K₂SO₄). The inclusion of additional presulfate ion-containing compounds in the media of the present disclosure can also be envisioned.

Ratios

The media of the present disclosure can have various ratios of acids, dehydrating agents, and oxidizing agents. For instance, in some embodiments, the acid: dehydrating agent: oxidizing agent weight ratio varies from about 30:1:1 to about 4:2:1. In some embodiments, the acid: dehydrating agent: oxidizing agent weight ratio varies from about 1:1:1 to about 20:8:1. In some embodiments, the acid: dehydrating agent: oxidizing agent weight ratio varies from about 1:1:1 to about 20:2:1. In additional embodiments, the acid: dehydrating agent: oxidizing agent weight ratio varies from about 10:1:1 to about 8:8:1. In more specific embodiments, the acid: dehydrating agent: oxidizing agent weight ratio is about 8: 8: 1. In further embodiments, the acid: dehydrating agent weight ratio varies from about 2:1 to about 20:1. In additional embodiments, the acid: dehydrating agent: oxidizing agent weight ratio is about 1:1:1. In further embodiments, the acid: dehydrating agent: oxidizing agent weight ratio is about 15:1:1.

In some embodiments, the weight ratio of the carbon nanotubes to the medium varies from about 1:200 to about 1:4. In more specific embodiments, the weight ratio of carbon nanotubes to the medium is about 1:10. Additional weight ratios can also be envisioned.

Media with H₂SO₄ and Oleum

In some embodiments, the media of the present disclosure include sulfuric acid as the acid component and oleum as the dehydrating agent component. In additional embodiments, the media of the present disclosure include sulfuric acid as the acid component, oleum as the dehydrating agent component, and a persulfate ion-containing compound as the oxidizing agent component. In further embodiments, the persulfate ion-containing compound includes ammonium persulfate.

In some embodiments, the oleum has a free sulfur trioxide content of about 20% by weight of the oleum. In more specific embodiments, the medium that includes oleum has a free sulfur trioxide content that ranges from about 0% (i.e. 100% sulfuric acid) to about 20% by weight of the medium. In some embodiments, the medium that includes oleum has a free sulfur trioxide content that ranges from about 1% to about 2% by weight of the medium. In more specific embodiments, the medium that includes oleum has a free sulfur trioxide content of about 1.6% by weight of the medium. In some embodiments, the ratio of the oxidizing agent to oleum in the oleum-containing media is from about 1 g to about 4 g of oxidizing agent per 10 mL of oleum. Additional ratios can also be envisioned.

Media with H₂SO₄ and P₂O₅

In some embodiments, the media of the present disclosure include sulfuric acid as the acid component and diphosphorus pentoxide as the dehydrating agent component. In additional embodiments, the media of the present disclosure include sulfuric acid as the acid component, diphosphorus pentoxide as the dehydrating agent component, and a persulfate ion-containing compound as the oxidizing agent component. In further embodiments, the persulfate ion-containing compound includes ammonium persulfate.

In some embodiments, the weight ratio of sulfuric acid to diphosphorus pentoxide to the oxidizing agent varies from about 30:1:1 to about 4:2:1 In more specific embodiments, the ratio of sulfuric acid to diphosphorus pentoxide to the oxidizing agent is about 15:1:1. Additional weight ratios can also be envisioned.

Graphene Nanoribbon Formation

In some embodiments, graphene nanoribbons form when carbon nanotubes are exposed to a medium. Without being bound by theory, it is envisioned that graphene nanoribbons can form from carbon nanotubes by various mechanisms. For instance, in some embodiments, the exposing of the carbon nanotubes to a medium leads to the opening of the carbon nanotubes parallel to their longitudinal axis to form graphene nanoribbons. In some embodiments, the carbon nanotubes may become completely opened to form graphene nanoribbons. In some embodiments, the carbon nanotubes may become partially opened.

Without again being bound by theory, it is envisioned that, in some embodiments (e.g., embodiments where the carbon nanotubes include multi-walled carbon nanotubes), the exposing of carbon nanotubes to a medium leads to intercalation of medium components between the walls of the carbon nanotubes. In some embodiments, such intercalation creates a strain within the carbon nanotubes. In some embodiments, the created strain leads to the longitudinal opening of the carbon nanotubes to form graphene nanoribbons.

In some embodiments, it is envisioned that a desirable oxidation potential (or chemo-electrochemical potential) of a medium creates a driving force for graphene nanoribbon formation. In some embodiments, the driving force for the intercalated medium components between the walls of the carbon nanotubes (e.g., the walls of multi-walled carbon nanotubes) is larger than the C—C bond breaking threshold of the carbon nanotubes. In some embodiments, the C—C bond breaking threshold of the carbon nanotubes in a medium varies from about 200 mV to about 300 mV when compared to pure sulfuric acid.

In some embodiments, medium components may be chosen such that the redox potential of a medium is high enough to intercalate between the walls of carbon nanotubes (e.g., the walls of multi-walled carbon nanotubes) to open the carbon nanotubes, but low enough to not significantly damage the formed graphene nanoribbons by covalent oxidation. In more specific embodiments, medium components are chosen such that the redox potential of the medium ranges from about 200 mV (i.e., redox potential to break the C—C bonds of carbon nanotube walls) to about 350 mV (i.e., redox potential beyond which covalent oxidation may occur) when compared to pure sulfuric acid.

Termination of Graphene Nanoribbon Formation

In some embodiments, the methods of the present disclosure also include a step of terminating the formation of graphene nanoribbons. For instance, in some embodiments, the exposure time of carbon nanotubes to a medium is limited in order to control the quality of graphene nanoribbon formation. Without being bound by theory, it is envisioned that, by controlling the time of exposure of carbon nanotubes to media, less oxidation is likely to occur.

In some embodiments, the exposure of carbon nanotubes to a medium is terminated from about 1 minute to about 180 minutes after exposing the carbon nanotubes to the medium. In some specific embodiments, the exposure of carbon nanotubes to a medium is terminated from about 10 minutes to about 120 minutes after exposing the carbon nanotubes to the medium.

In some embodiments, the exposure of carbon nanotubes to a medium is terminated from about 1 minute to about 10 minutes after exposing the carbon nanotubes to the medium. In more specific embodiments, the exposure of carbon nanotubes to a medium is terminated about 10 minutes after exposing the carbon nanotubes to the medium. In additional embodiments, the exposure of carbon nanotubes to a medium is terminated about 120 minutes after exposing the carbon nanotubes to the medium.

Various methods may be utilized to terminate the formation of graphene nanoribbons. For instance, in some embodiments, the terminating occurs by quenching a medium that contains carbon nanotubes and medium components. In some embodiments, a dispersion of carbon nanotubes in a medium is quenched by addition of water to the dispersion. In some embodiments, the water is ice water.

In additional embodiments, the formation of graphene nanoribbons is terminated by separation of graphene nanoribbons from a medium. In some embodiments such separation occurs by centrifugation of the dispersion that contains graphene nanoribbons and medium components. In further embodiments, the separation occurs by filtration of the dispersion. Additional methods by which to terminate the formation of graphene nanoribbons can also be envisioned.

Separation of Graphene Nanoribbons

In some embodiments, the methods of the present disclosure also include a step of separating the formed graphene nanoribbons from a medium. In some embodiments, the separation step may be the same step as a termination step. In some embodiments, the separation occurs by centrifugation of the dispersion. In further embodiments, the separation occurs by filtration of the dispersion. Additional methods by which to separate graphene nanoribbons from a medium can also be envisioned.

Formed Graphene Nanoribbons

The methods of the present disclosure can be utilized to form various types of graphene nanoribbons. For instance, in some embodiments, the formed graphene nanoribbons include a plurality of layers. In some embodiments, the formed graphene nanoribbons have from about 1 layer to about 100 layers. In some embodiments, the formed graphene nanoribbons have from about 1 layer to about 4 layers. In some embodiments, the formed graphene nanoribbons have from about 20 layers to about 80 layers. In some embodiments, the formed graphene nanoribbons have a flattened structure. In some embodiments, the formed graphene nanoribbons have a foliated structure.

In some embodiments, the formed graphene nanoribbons are non-oxidized. In some embodiments, the non-oxidized graphene nanoribbons have an oxygen content of less than about 5% by weight of the graphene nanoribbons. In more specific embodiments, the non-oxidized graphene nanoribbons have an oxygen content of less than about 2.5% by weight of the graphene nanoribbons.

In some embodiments, the formed graphene nanoribbons lack graphene oxide nanoribbons. In some embodiments, the formed graphene nanoribbons are un-functionalized. In some embodiments, the formed graphene nanoribbons are in pristine form. In some embodiments, the formed graphene nanoribbons are substantially defect-free.

In additional embodiments, the present disclosure pertains to the actual graphene nanoribbons that are formed by the methods of the present disclosure. In more specific embodiments, the graphene nanoribbons are derived from carbon nanotubes. In some embodiments, the graphene nanoribbons are non-oxidized. In some embodiments, the graphene nanoribbons are derived from multi-walled carbon nanotubes. In some embodiments, the graphene nanoribbons have an oxygen content of less than about 5% by weight of the graphene nanoribbons. In some embodiments, the graphene nanoribbons have an oxygen content of less than about 2.5% by weight of the graphene nanoribbons.

In some embodiments, the graphene nanoribbons include multiple layers. In some embodiments, the layers range from about 1 layer to about 100 layers. In some embodiments, the layers range from about 1 layer to about 4 layers. In some embodiments, the graphene nanoribbons have from about 20 layers to about 80 layers.

In some embodiments, the graphene nanoribbons have a flattened structure. In some embodiments, the graphene nanoribbons are substantially defect-free. In some embodiments, the graphene nanoribbons are un-functionalized. In some embodiments, the graphene nanoribbons are pristine. In some embodiments, the graphene nanoribbons have a foliated structure.

### Advantages

The present disclosure provides scalable, safe and cost effective methods of producing graphene nanoribbons that are non-oxidized and defect free in yields that approach 100%. Furthermore, the methods of the present disclosure can occur in short periods of time (e.g., 5 minutes) without requiring subsequent processing steps. For instance, in some embodiments, the methods of the present disclosure lack a reduction step after the formation of graphene nanoribbons.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### GNR Production by Exposure of MWNTs to (NH₄)₂S₂O₈/H₂SO₄/Oleum

In this Example, GNRs were produced by exposing MWNTs to an oxidative anhydrous acidic medium that contained (NH₄)₂S₂O₈, H₂SO₄, and oleum ((NH₄)₂S₂O₈/H₂SO₄/oleum). The reactive mixture was prepared by dissolving 10 g of (NH4)2S2O8 in 80 mL of fuming sulfuric acid made by combining 40 mL of 96% sulfuric acid and 40 mL of 20% oleum (i.e., oleum containing a free sulfur trioxide content of about 20% by weight of the oleum), and stirring for ˜10 min until the (NH₄)₂S₂O₈ was dissolved. MWNTs (2 g) were then added into the as-prepared solution and swirled slowly for 2 h. Thereafter, the reaction was quenched with ice-water. The as-prepared products were then separated from the diluted reaction mixture by filtration or centrifugation. Next, the products were washed with water and dried.

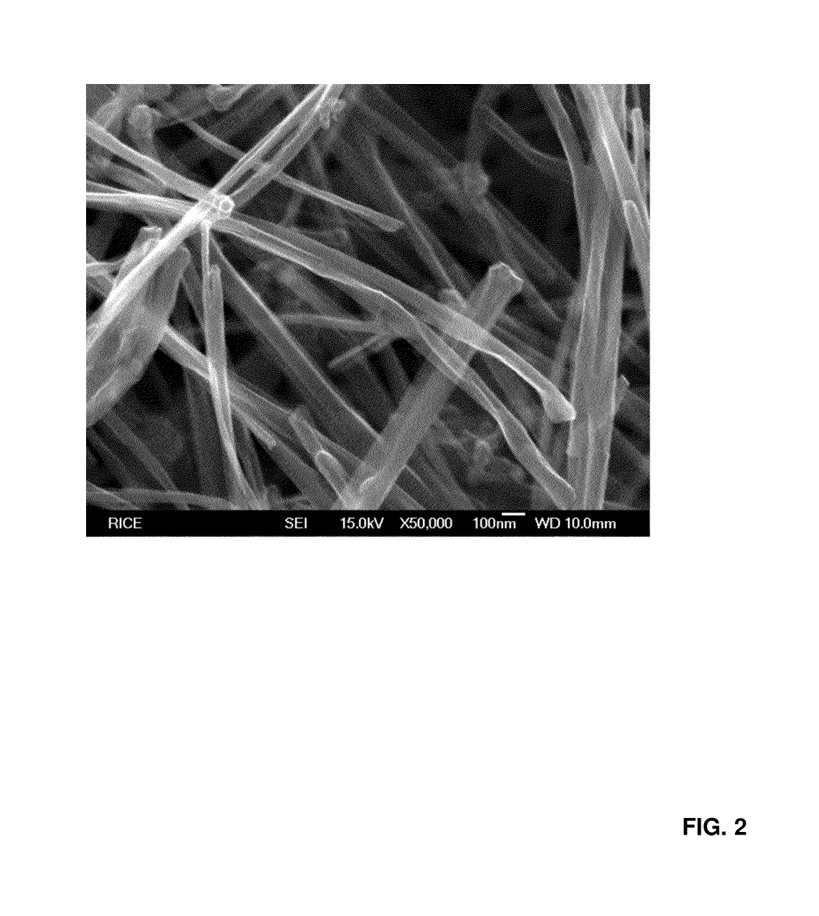

The performed analysis on the products indicates that the above method resulted in the unzipping of MWNTs to form GNRs. FIG. 2 shows SEM images of the products produced by the abovementioned procedure. FIG. 2 demonstrates that the vast majority of MWNTs were opened longitudinally to form GNRs.

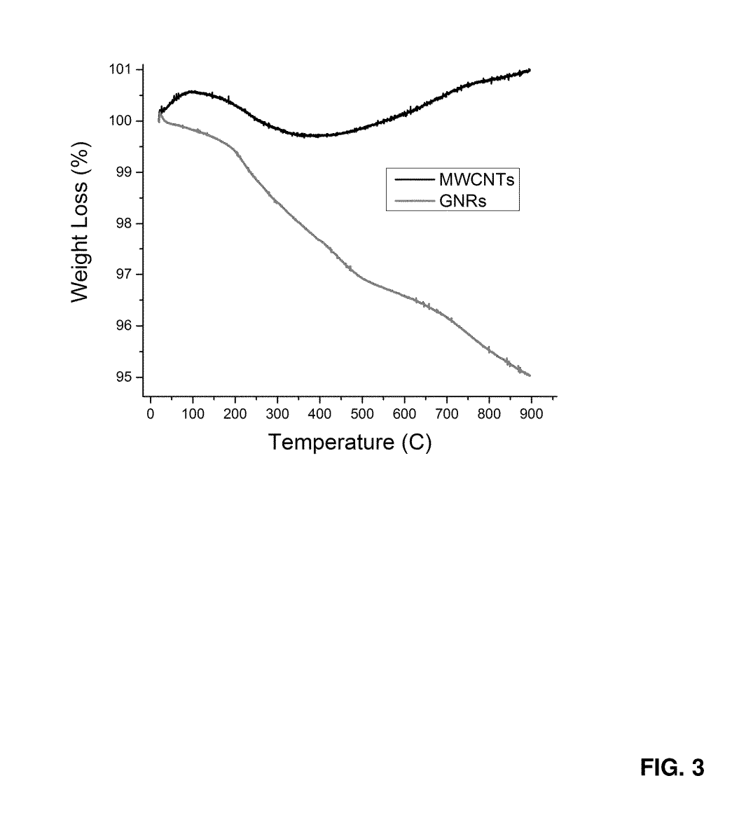

In addition, the TGA in FIG. 3 shows that the produced GNRs were not significantly oxidized. By way of information, graphene oxide nanoribbons (GONRs) and graphene oxide (GO) samples have distinct weight loss regions between ˜160 ° C. and ˜250° C. associated with decomposition of oxygen functionalities. The weight loss in this region constitutes about 25% to about 30% of the original weight. The total weight loss by 900° C. for GO is normally more than about 60%.

Unlike GO and GONRs, the GNRs of this Example lose only 5% of their weight. Moreover, the characteristic weight loss in the 160° C. to 220° C. region is not registered. Instead, the main weight loss (2.7%) is registered at higher temperatures in the temperature interval between 200° C. to 500° C. This weight loss can be attributed to the insignificant amount of the oxygen functionalities, which are more stable compared to the functionalities in GO. Such weight loss can also be attributed to the removal of residual intercalated sulfuric acid.

Likewise, the 1% weight loss at temperatures above 700° C. can be attributed to the loss of carbon associated with rearrangement of carbon framework at the newly formed edges of GNRs.

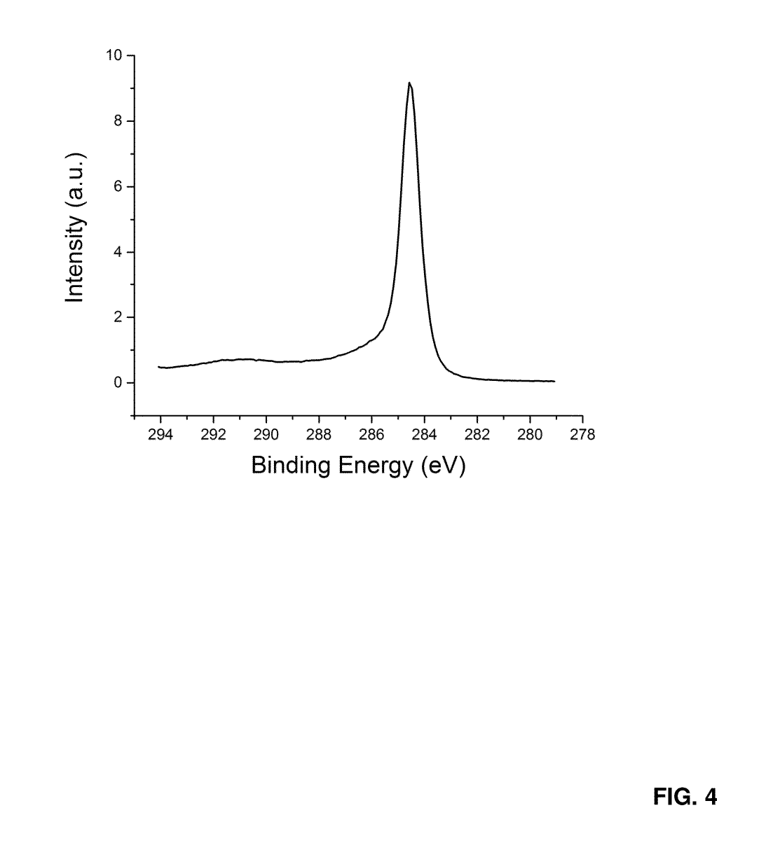

FIG. 4 shows the Cls XPS spectrum of the GNRs. The spectrum contains a single peak at 284.5 eV, corresponding to elemental carbon. The weak π-π* interaction band at 291 eV is indicative of the intact graphitic carbon. The survey spectrum shows only 2.5% to 4.5% oxygen on different spots of different samples, which is typical for any non-oxidized carbon material. Thus, based on the TGA and XPS data, Applicants conclude that the as-prepared GNRs are not oxidized.

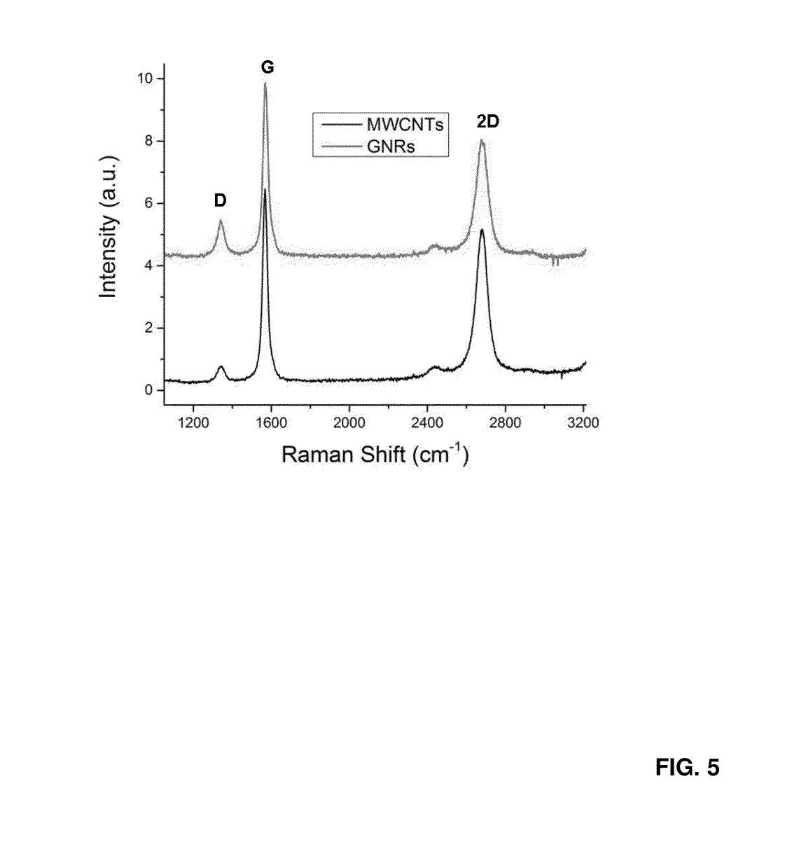

FIG. 5 shows the Raman spectra of the produced GNRs (red) and the precursor MWNTs (black). The higher D-peak in GNRs compared to that in MWNTs is attributed to the ribbon's edges, which are formed as a result of unzipping.

Without being bound by theory, it is envisioned that the anhydrous nature of the medium contributes to the effective unzipping of the MWNTs to form GNRs. Moreover, best results in this Example can be obtained when (NH₄)₂S₂O₈ is dissolved in the 1.6% oleum (i.e. a mixture containing 1.6% of free SO₃). However, the system works in the range of oleum concentrations from 0% (i.e. 100% H₂SO₄) through 10% (i.e., a mixture containing 10% of free SO₃).

### EXAMPLE 2

### GNR Production by Exposure of MWNTs to (NH₄)₂S₂O₈/H₂SO₄/P₂O₅

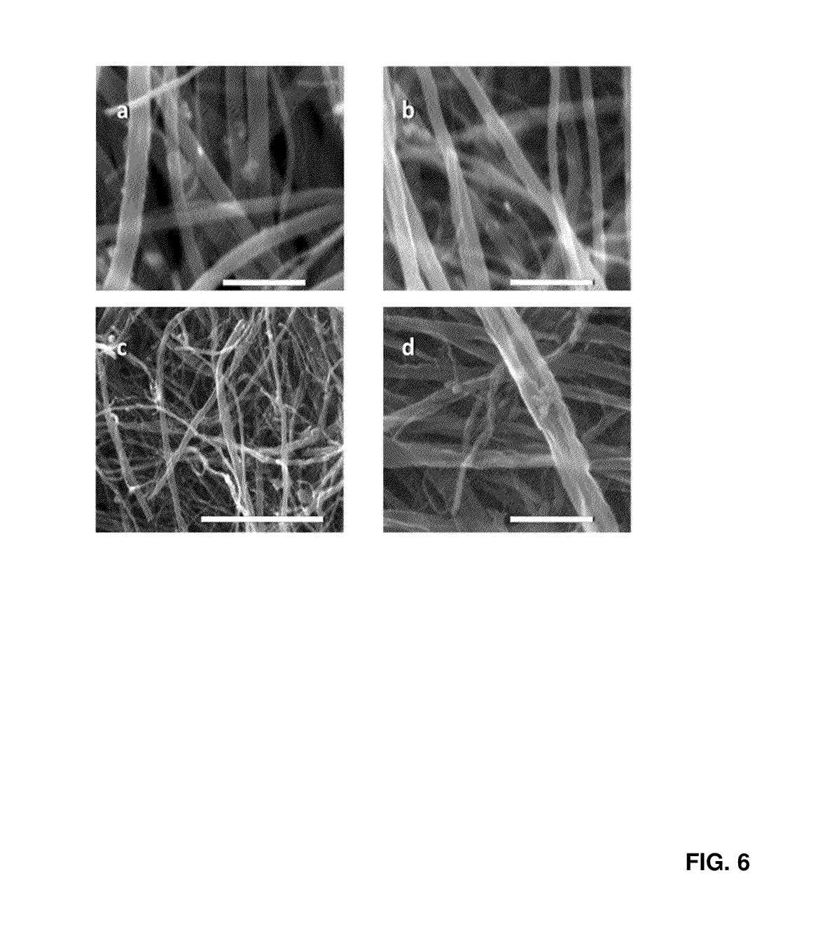

In this Example, GNRs were produced by exposing MWNTs to an oxidative anhydrous acidic medium that contained (NH₄)₂S₂O₈, H₂SO₄, and P₂O₅ ((NH₄)₂S₂O₈/H₂SO₄/P₂O₅). The reactive mixture was prepared by dissolving 10 g of (NH₄)₂S₂O₈ and 10 g of P₂O₅ in 70-80 mL of 96% sulfuric acid. The mixture was then swirled for about 10 minutes until the (NH₄)₂S₂O₈ and P₂O₅ were dissolved. MWNTs (2 g) were added into the as-prepared dispersion and swirled slowly for 2 h. The reaction was then quenched with ice-water. Next, the products were separated from the diluted reaction mixture by filtration or centrifugation. Thereafter, the products were washed with water and dried. As illustrated in the SEM images in FIG. 6, the aforementioned steps resulted in the unzipping of MWNTs and the formation of GNRs.

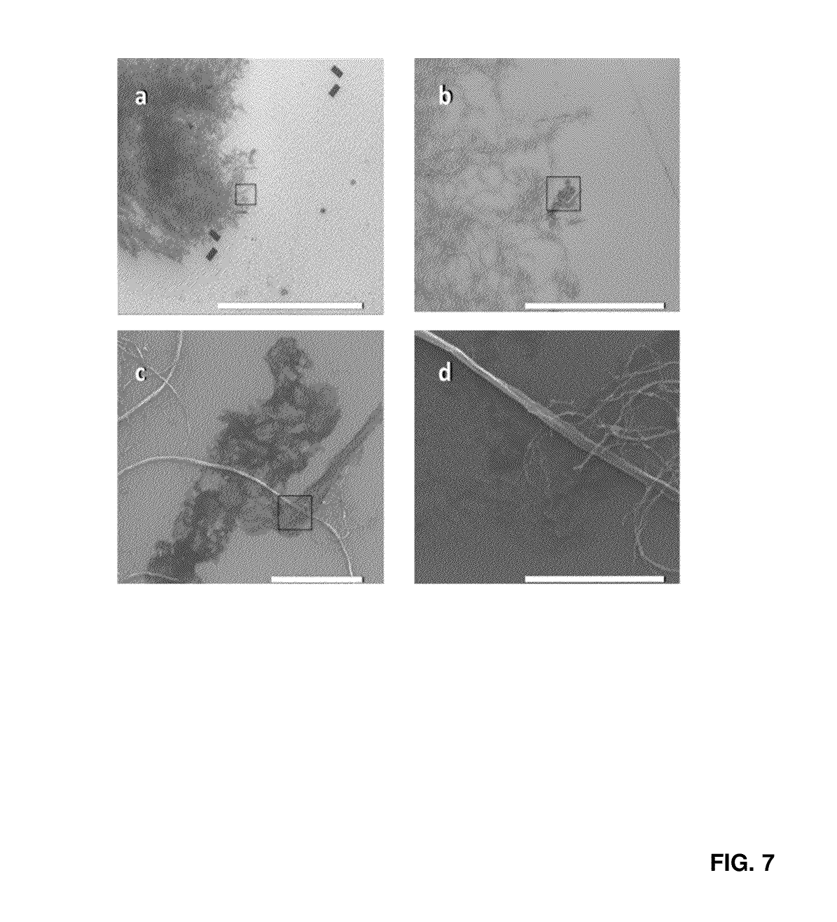

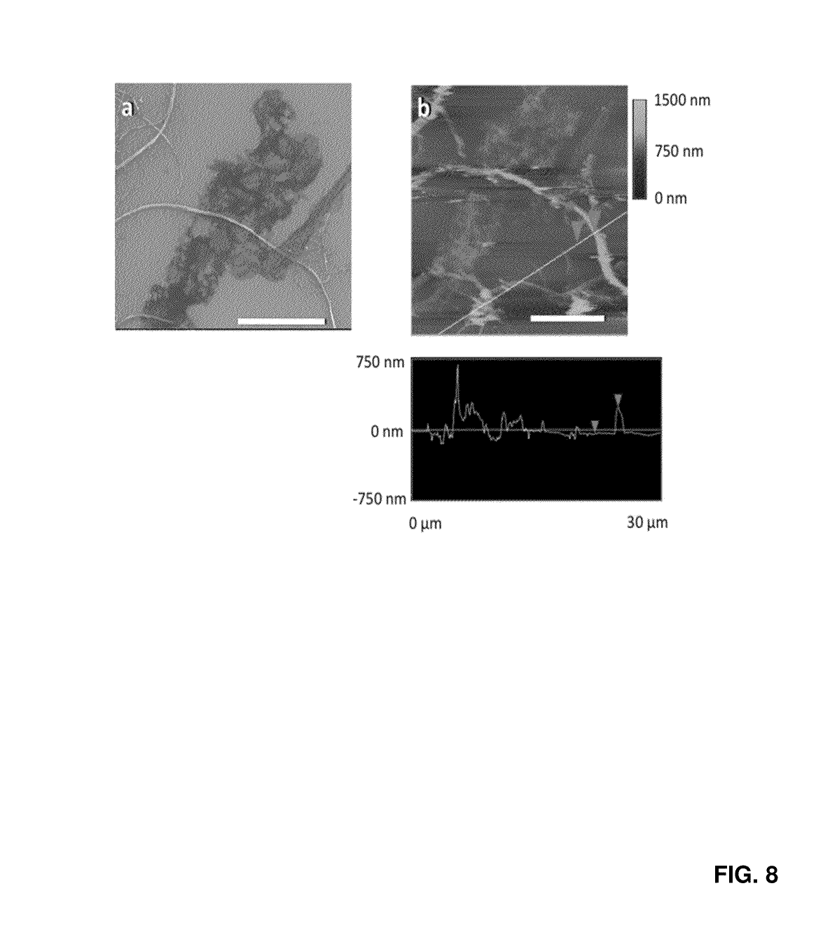

Additional results from a similar experiment that utilized Nano Tech Labs (NTL) MWNTs are shown in FIGS. 7-8. The same aforementioned experimental protocol was utilized. Such results affirm that (NH₄)₂S₂O₈/H₂SO₄/P₂O₅ can be utilized as an oxidative anhydrous acidic medium to produce GNRs from MWNTs.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of producing graphene nanoribbons,
wherein the method comprises exposing carbon nanotubes to a medium to form a dispersion of carbon nanotubes in the medium,
wherein the medium comprises:
(a) an acid,
(b) a dehydrating agent, and
(c) an oxidizing agent; and
wherein the exposing results in formation of the graphene nanoribbons from the carbon nanotubes.

2. The method of claim 1, wherein the carbon nanotubes comprise multi-walled carbon nanotubes.

3. The method of claim 1, wherein the exposing comprises stirring the dispersion.

4. The method of claim 1, wherein the medium comprises a solution.

5. The method of claim 1, wherein the exposing occurs at temperatures of about 5° C. to about 100° C.

6. The method of claim 1, wherein the exposing occurs at a temperature of about 100° C.

7. The method of claim 1, wherein the exposing occurs for about 1 minute to about 180 minutes.

8. The method of claim 1, wherein the exposing occurs for about 1 minute to about 10 minutes.

9. The method of claim 1, wherein the acid is capable of intercalating between the walls of the carbon nanotubes in the dispersion.

10. The method of claim 1, wherein the acid is selected from the group consisting of sulfuric acid, chlorosulfonic acid, nitric acid, perchloric acid, perbromic acid, periodic acid, and combinations thereof.

11. The method of claim 1, wherein the acid comprises sulfuric acid.

12. The method of claim 1, wherein the dehydrating agent is selected from the group consisting of diphosphorus pentoxide (P₂O₅), sulfur trioxide (SO₃), alumina (Al₂O₃), calcium chloride (CaCl₂), calcium sulfate (CaSO₄), magnesium sulfate (MgSO₄), potassium carbonate (K₂CO₃), sodium sulfate (Na₂SO₄), and combinations thereof.

13. The method of claim 1, wherein the dehydrating agent comprises diphosphorus pentoxide (P₂O₅).

14. The method of claim 1, wherein the dehydrating agent comprises sulfur trioxide (SO₃).

15. The method of claim 1, wherein the dehydrating agent comprises oleum.

16. The method of claim 15, wherein the oleum has a free sulfur trioxide (SO₃) content of about 20% by weight of the oleum.

17. The method of claim 15, wherein the medium has a free sulfur trioxide (SO3) content that ranges from about 0% to about 10% by weight of the medium.

18. The method of claim 1, wherein the oxidizing agent is selected from the group consisting of hydrogen peroxide, chromates, dichromates, chlorates, perchlorates, osmium tetroxide, nitrogen oxides nitrates, nitric acid, persulfate ion-containing compounds, and combinations thereof.

19. The method of claim 1, wherein the oxidizing agent comprises a persulfate ion-containing compound.

20. The method of claim 19, wherein the persulfate ion-containing compound comprises a persulfate ion selected from the group consisting of dipersulfate (S₂O₈²⁻), peroxymonosulfate (SO₅²⁻), hydrogen dipersulfate (HS₂O₈⁻), hydrogen peroxymonosulfate (HSO₅⁻), peroxydisulfuric acid (H₂S₂O₈), peroxymonosulfuric acid (H₂SO₅⁻), and combinations thereof.

21. The method of claim 19, wherein the persulfate ion-containing compound comprises a cation selected from the group consisting of ammonium, sodium, potassium, lithium, cesium, group 1 metals, group 2 metals, and combinations thereof.

22. The method of claim 1, wherein the oxidizing agent comprises ammonium persulfate.

23. The method of claim 1, wherein the acid: dehydrating agent: oxidizing agent weight ratio varies from about 1:1:1 to about 20:8:1.

24. The method of claim 1, wherein the acid: dehydrating agent: oxidizing agent weight ratio is about 8:8:1.

25. The method of claim 1, wherein the acid: dehydrating agent weight ratio varies from about 2:1 to about 20:1.

26. The method of claim 1,
wherein the acid comprises sulfuric acid, and
wherein the dehydrating agent comprises oleum.

27. The method of claim 26, wherein the oleum has a free sulfur trioxide (SO₃) content of about 20% by weight of the oleum.

28. The method of claim 26, wherein the oxidizing agent comprises a persulfate ion-containing compound.

29. The method of claim 28, wherein the persulfate ion-containing compound comprises ammonium persulfate.

30. The method of claim 26, wherein the medium has a free sulfur trioxide (SO₃) content that ranges from about 0% to about 10% by weight of the medium.

31. The method of claim 1,
wherein the acid comprises sulfuric acid, and
wherein the dehydrating agent comprises diphosphorus pentoxide (P₂O₅).

32. The method of claim 31, wherein the oxidizing agent comprises a persulfate ion-containing compound.

33. The method of claim 32, wherein the persulfate ion-containing compound comprises ammonium persulfate.

34. The method of claim 1, wherein the exposing opens the carbon nanotubes parallel to their longitudinal axis to form graphene nanoribbons.

35. The method of claim 1, wherein the exposing leads to intercalation of the medium components between the walls of the carbon nanotubes,
wherein the intercalation creates a strain within the carbon nanotubes, and
wherein the strain leads to the longitudinal opening of the carbon nanotubes to form graphene nanoribbons.

36. The method of claim 1, further comprising a step of terminating the formation of graphene nanoribbons.

37. The method of claim 36, wherein the terminating occurs for about 1 minute to about 180 minutes after exposing the carbon nanotubes to the medium.

38. The method of claim 36, wherein the terminating occurs for about 1 minute to about 10 minutes after exposing the carbon nanotubes to the medium.

39. The method of claim 36, wherein the terminating occurs by quenching the dispersion.

40. The method of claim 1, wherein the method lacks a reduction step after the formation of graphene nanoribbons.

41. The method of claim 1, wherein the formed graphene nanoribbons comprise from about 1 layer to about 100 layers.

42. The method of claim 1, wherein the formed graphene nanoribbons are non-oxidized.

43. The method of claim 42, wherein the graphene nanoribbons have an oxygen content of less than about 5% by weight of the graphene nanoribbons.

44. The method of claim 1, wherein the formed graphene nanoribbons lack graphene oxide nanoribbons.

45. A graphene nanoribbon,
wherein the graphene nanoribbon is derived from carbon nanotubes, and
wherein the graphene nanoribbon is non-oxidized.

46. The graphene nanoribbon of claim 45, wherein the graphene nanoribbon is derived from multi-walled carbon nanotubes.

47. The graphene nanoribbon of claim 45, wherein the graphene nanoribbon has an oxygen content of less than about 5% by weight of the graphene nanoribbon.

48. The graphene nanoribbon of claim 45, wherein the graphene nanoribbon has an oxygen content of less than about 2.5% by weight of the graphene nanoribbon.

49. The graphene nanoribbon of claim 45, wherein the graphene nanoribbon comprises a plurality of layers.

50. The graphene nanoribbon of claim 45, wherein the graphene nanoribbon comprises from about 1 layer to about 100 layers.

51. The graphene nanoribbon of claim 45, wherein the graphene nanoribbon has a flattened structure.

52. The graphene nanoribbon of claim 45, wherein the graphene nanoribbon has a foliated structure.

53. The graphene nanoribbon of claim 45, wherein the graphene nanoribbon is substantially free of defects.

54. The graphene nanoribbon of claim 45, wherein the graphene nanoribbon is un-functionalized.

55. The graphene nanoribbon of claim 45, wherein the graphene nanoribbon is pristine.
